(19) United States
(12) Patent Application Publication
(10) Pub. No.: US 2011/0081266 A1
(43) Pub. Date: Apr. 7, 2011

(54) FAN, BEARING AND SLEEVE THEREOF

(76) Inventors: Wei-Chun HSU, Taoyuan Hsien (TW); Shun-Chen Chang, Taoyuan Hsien (TW); Wen-Shi Huang, Taoyuan Hsien (TW)

(21) Appl. No.: 12/967,944

(22) Filed: Dec. 14, 2010

Related U.S. Application Data
(63) Continuation of application No. 11/709,266, filed on Feb. 22, 2007.

(30) Foreign Application Priority Data
Mar. 31, 2006 (TW) 095111465

(51) Int. Cl. F01D 25/16; F16C 33/10

(52) U.S. Cl. 417/423.13; 384/291

(57) ABSTRACT

A bearing includes an axial hole and a plurality of first grooves. The first grooves are formed on the inner wall of the bearing, and extends through the top surface and to the outer wall of the bearing. The lubricant oil originally held in the bearing can be guided to flow around the whole bearing effectively.

### CROSS REFERENCE TO RELATED APPLICATIONS

This is a Continuation application of U.S. patent application Ser. No. 11/709,266 filed Feb. 22, 2007, which is a non-provisional application which claims priority under 35 U.S.C. §119(a) on Patent Application No(s). 095111465 filed in Taiwan, Republic of China on Mar. 31, 2006. the entire contents of which are hereby incorporated by reference.

### BACKGROUND OF THE INVENTION

1. Field of Invention

The invention relates to a fan, a bearing and a sleeve thereof, and in particular, to a fan, a bearing and a sleeve thereof with reduced consumption and volatilization of lubrication fluid.

2. Related Art

Motors have been widely used in vehicles, fans, pumps and computer peripherals, such as printers and scanners, and the bearing structure of a motor directly influences the quality of the motor. In order to enhance the self-lubrication of the bearing and prevent impact, a hearing is usually adopted. The conventional bearing is made of a porous material, has a plurality of micro voids and contains lubrication oil. When the bearing is rotated, the bearing allows the lubrication oil to fill into a gap between a shaft and the bearing to achieve the function of lubrication according to the capillary action of the micro voids.

Referring to FIG. 1, a conventional bearing 10 has an axial hole 101 for accommodating a shaft 11. The hearing 10 is disposed in a sleeve 12 of a stator base. Because a top surface 102 of the bearing 10 is in direct contact with the outside, the lubrication oil volatilizes from the top surface 102 of the bearing 10. In addition, the lubrication oil leaks from a gap between the hearing 10 and the shalt 11, and a gap between the hearing 10 and the sleeve 12. More particularly, when the bearing 10 is placed upended, such leakage become more serious that the lifetime of the bearing 10 is shortened, or the overall operation becomes rough due to insufficient lubrication oil and the resultant excessive frictional force between the bearing and the shaft 11 or the sleeve 12.

In order to solve this problem, as shown in FIG. 2, a baffle 13 is disposed on the top surface 102 of the bearing 10 to block the leaking path of the lubrication oil. However, the effect is limited because the lubrication oil may still leak to the outside through the gap between the bearing 10 and the shaft 11 and the gap between the bearing 10 and the sleeve 12.

In view of this, it is therefore an important subject of the invention to provide a bearing structure capable of effectively reducing the consumption and volatilization of lubrication fluid while providing a circulating lubrication loop to reduce the friction between the sleeve and the bearing, thus lengthening the lifetime of the bearing.

### SUMMARY OF THE INVENTION

In view of the foregoing, the invention is to provide a bearing structure capable of effectively reducing the lubrication fluid consumption and volatilization, providing a circulating lubrication loop to reduce the friction between a sleeve and a bearing, and thereby lengthening the lifetime of the bearing.

To achieve the above, the invention discloses a bearing including an axial hole and a plurality of first grooves. The first grooves are formed on an inner surface of the axial hole and extend to a top surface of the bearing.

To achieve the above, the invention also discloses a hearing structure, which is used in conjunction with a shaft and disposed in a sleeve. The hearing has an axial hole and a plurality of first grooves. The shaft passes through the axial hole. The first grooves are formed on a first wall of the bearing and extend to a top surface of the hearing.

In addition, the invention further discloses a fan including an impeller, a stator structure and a rotor structure. The impeller has a hub and a plurality of blades mounted around a periphery of the hub. The stator structure has a magnetic element and a sleeve. The rotor structure is disposed corresponding to the stator structure and has a shaft and a bearing structure. The shaft is connected to the hub. The hearing is disposed in the sleeve. The hearing includes an axial hole and a plurality of first grooves. The shaft passes through the axial hole. The first grooves are formed on a first wall of the bearing and extend to the top surface of the bearing.

As mentioned hereinabove, in the fan, the bearing according to the invention is used in conjunction with a shaft and a sleeve, and the shaft passes through the bearing, which is disposed in a chamber of the sleeve. The bearing is constituted by the axial hole, the first grooves, a plurality of chamfers and at least one cut side. Compared with the prior art, when the bearing is rotating, the first grooves, the plurality of chamfers and the cut side can mix the oil gas of the lubrication fluid sufficiently, to form a circulating lubrication loop and to generate oil gas hydrodynamic pressure on the top surface and the periphery of the bearing. Thus, the thrust functions in the axial and radial directions can be generated in order to prevent the bearing from rubbing against the top surface and the inner wall of the sleeve, and to reduce the up and down vibrations of the bearing and the pneumatic hammer phenomenon without using the conventional resisting washer. In addition, the invention forms the circulating loop of the lubrication fluid in the closed chamber. Thus, the consumption and volatilization of the lubrication fluid can be reduced, the lifetime of the bearing can be lengthened, and the manufacturing cost can be decreased because the machining precision of the hearing does not have to be very high.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional bearing;

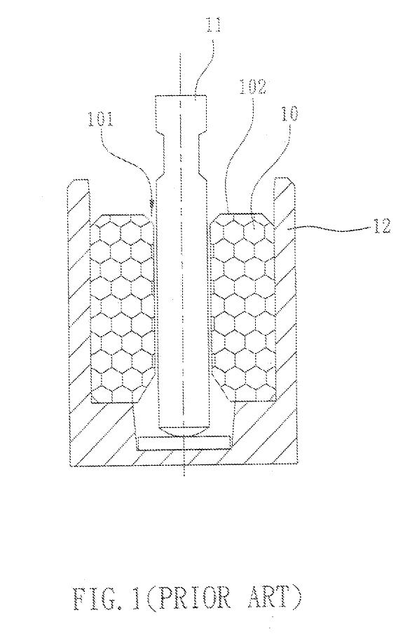

FIG. 2 is a schematic illustration showing another conventional hearing;

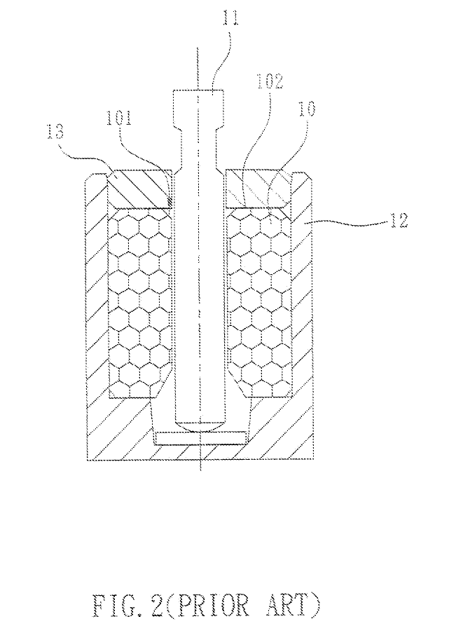

FIG. 3 is a schematic illustration showing a bearing according to an embodiment of the invention;

FIG. 4 is a schematic illustration showing another bearing according to the embodiment of the invention;

FIG. 5 is a schematic illustration showing a bearing structure according to another embodiment of the invention;

FIG. 6 is a schematic illustration showing a gap formed between a rotating bearing structure and a sleeve according to the embodiment of the invention; and

FIG. 7 is a schematic illustration showing a fan according to the embodiment of the invention.

### DETAILED DESCRIPTION OF THE INVENTION

The present invention will be apparent from the following detailed description, which proceeds with reference to the accompanying drawings, wherein the same references relate to the same elements.

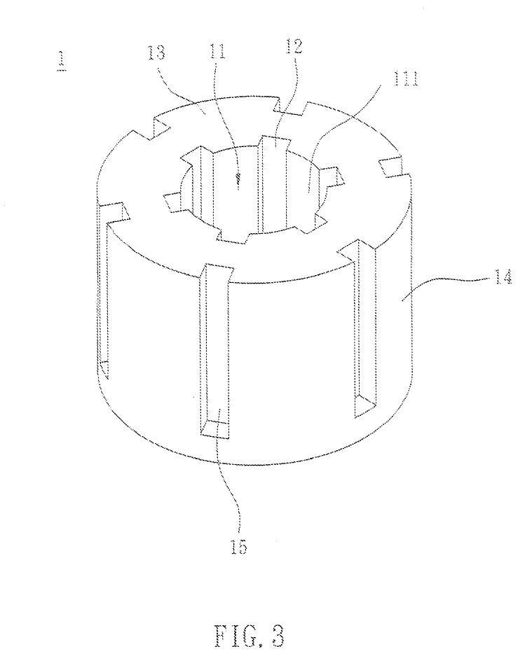

Referring to FIG. 3, a bearing 1 according to the embodiment of the invention includes an axial hole 11 and a plurality of first grooves 12. In this embodiment, the first grooves 12 are disposed on an inner surface 111 of the axial hole 11 and extend to a top surface 13 of the hearing 1. The first grooves 12 extend in a direction parallel to the axial direction of the axial hole 11, or extend helically (not shown) on the inner surface 111 of the axial hole 11.

A plurality of second grooves 15 can be formed on a periphery 14 of the bearing 1. The second grooves 15 respectively correspond to the first grooves 12, or are correspondingly formed between the first grooves 12 (not shown). When the hearing 1 is rotating, the lubrication fluid flows up to the top surface 13 of the hearing 1 along the first grooves 12, and then flows down along the second grooves 15 to form a circulating lubrication loop. The circulating lubrication loop can lubricate the top surface 13 of the bearing 1 and prevent the lubrication fluid from over volatilizing and being over consumed on the top surface 13.

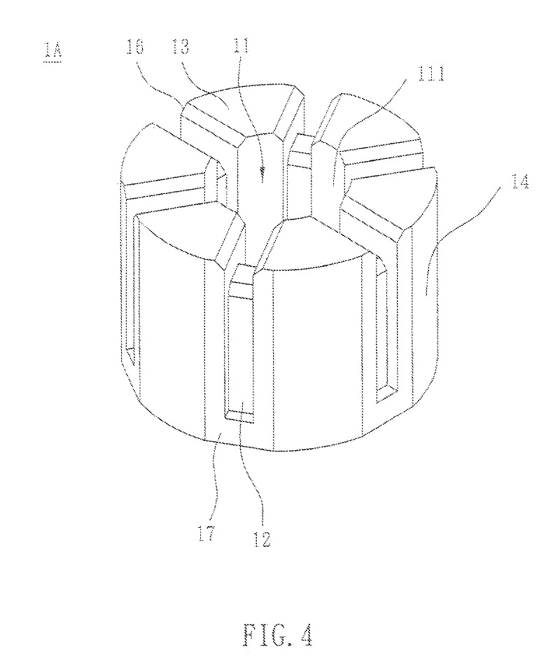

FIG. 4 is a schematic illustration showing another hearing 1A according to the embodiment of the invention. Referring to FIG. 4, the difference between another hearing 1A and the bearing 1 shown in FIG. 3 is that the periphery 14 of the bearing 1A is formed with the second grooves 15, which do not correspond to the first grooves 12. Instead, the first grooves 12 on the inner surface 111 of the axial hole 11 directly extend through the top surface 13 to the periphery 14 of the bearing 1A. The bearing 1A further includes chamfers 16 correspondingly formed at connection portions between the first grooves 12 and the top surface 13 of the bearing 1A. In this embodiment, the shape of the chamfer 16 is not particularly limited, and the chamfer 16 may have a sloped surface shown in FIG. 4 or an arc surface (not shown). The chamfers 16 aid the flow of lubrication fluid to the top surface 13.

The bearing 1A further includes at least one cut side 17 formed on the periphery 14 of the bearing 1A. The number of cut sides 17 is not particularly limited. If a plurality of cut sides 17 is formed, the cut sides 17 can be disposed symmetrically and have the same size. According to the structure designs of the first grooves 12, the chamfers 16 and the cut sides 17, the lubrication fluid can be smoothly guided to the top surface 13 and the cut side 17 when the bearing 1A is rotating. Thus, the mixing of the oil gas of the lubrication fluid can be enhanced to prevent pneumatic hammer phenomena.

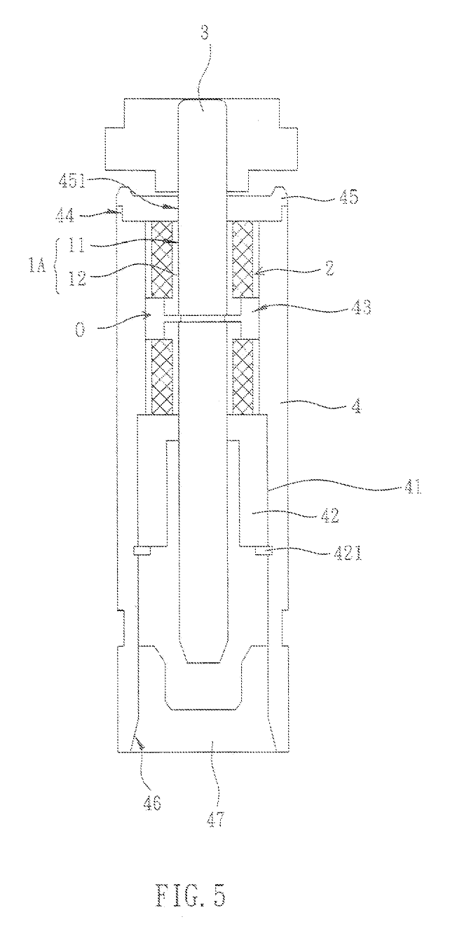

As shown in FIG. 5, a bearing structure 2 of this embodiment is used in conjunction with a shaft 3 and is disposed in a sleeve 4. The bearing structure 2 has at least one bearing having the same structure and function as that of the bearing 1 shown in FIG. 3 or the bearing 1A shown in FIG. 4. The bearing structure 2 can be applied to a rotor structure of a motor or a fan. Illustrations will be made by taking the bearing structure 2, having two bearings 1A, as an example.

The inner wall 41 of the sleeve 4 has a positioning part 42, through which the shaft 3 passes so that a chamber 43 is formed between the positioning part 42 and the top of the sleeve 4, and the bearing 1A is accommodated in the chamber 43. In this embodiment, the positioning part 42 has a positioning element 421, and the positioning part 42 can rest against the bearing 1A through the positioning element 421. In addition, the positioning part 42 and the sleeve 4 can also be formed as a monolithic piece.

The top of the sleeve 4 is formed with an opening 44 sealed by a cover 45. The shaft 3 passes through a through hole 451 at the middle of the cover 45. The cover 45 and the sleeve 4 can also be formed as a monolithic piece.

In addition, the bottom of the sleeve 4 of this embodiment is formed with an opening 46 sealed by a sealing element 47. The sealing element 47 and the sleeve 4 can also be formed as a monolithic piece.

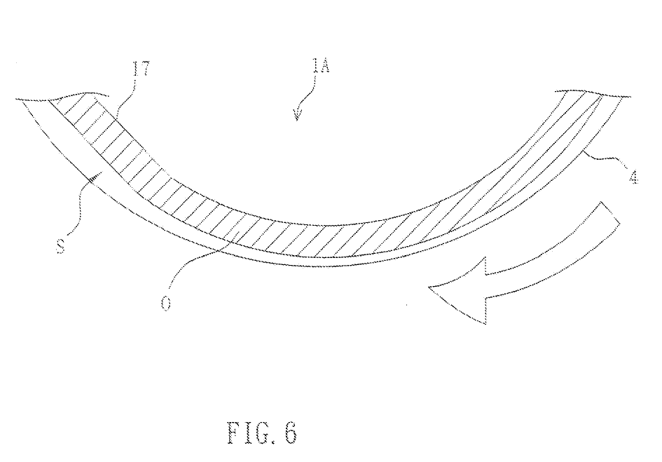

FIG. 6 is a schematic illustration showing a gap formed between a rotating bearing structure and a sleeve according to the embodiment of the invention. Referring to FIGS. 5 and 6, when the shaft 3 rotates with the bearing structure 2, the bearing 1A of the hearing structure 2 releases the lubrication oil, which is mixed with the air sufficiently to form the oil gas O. The oil gas O is guided into the outer wall of the cut side 17 along the first grooves 12. When the bearing structure 2 is rotating to gradually enlarge or reduce a gap S between the cut side 17 and the chamber 43, the bearing structure 2 presses the oil gas O to mix the oil gas O evenly. Meanwhile, the oil gas O also flows to the top surface 13 of the bearing 1A along the first groove 12 and the chamfer 16, and flows to the cut side 17 on the periphery 14 of the bearing 1A along the first groove 12, then filling into the gap S. When the gap S is filled with the oil gas O, the excess oil gas O is gathered to the chamber 43 on the outer portion of the bearing 1A, and the lubrication fluid O accumulates as the rotating speed of the rotor structure increases. The gathered oil gas O can fill the gap between the bearing 1A and the shaft 3 and the first grooves via capillary action to form a circulating lubrication loop.

The oil gas O of the circulating lubrication loop can flow to the top surface 13 of the bearing 1A smoothly and can generate oil gas hydrodynamic pressure between the bearing 1A and the cover 45. Thus, the hearing structure 2 has an axial thrust function that prevents the bearing 1A from rubbing against the cover 45 without the use of a resisting washer. In addition, the oil gas O in the circulating lubrication loop can generate hydrodynamic pressure between the bearing 1A and the sleeve 4 according to the dimensional change of the gap S, and radial thrust can be generated.

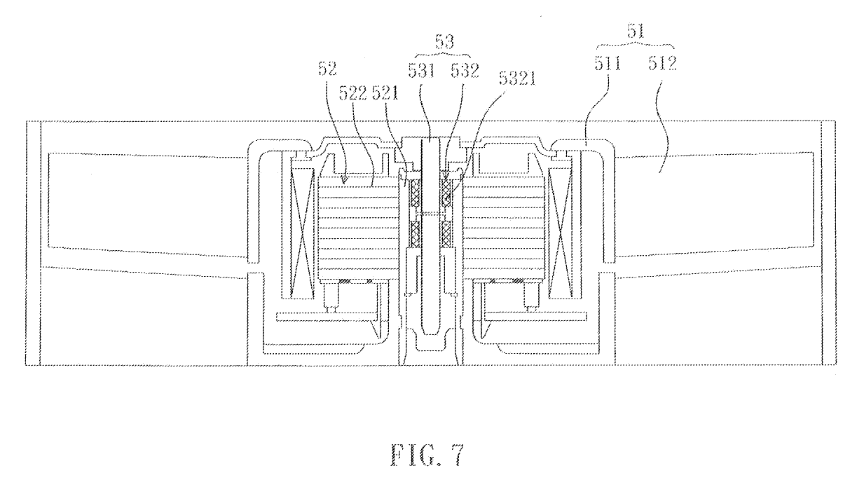

Referring to FIG. 7, a fan 5 includes an impeller 51, a stator structure 52 and a rotor structure 53. In this embodiment, the impeller 51 has a huh 511 and a plurality of blades 512. The blades 512 are mounted around the periphery of the huh 511. The stator structure 52 has a sleeve 521 and a magnetic element 522.

The rotor structure 53 is disposed corresponding to the stator structure 52 and has a shaft 531 and a hearing structure 532. The shaft 531 is connected to the hub 511. The hearing structure 532 is disposed in the sleeve 521. The bearing structure 532 includes at least one hearing 5321.

Since the bearing 5321, the bearing structure 532, the shaft 531 and the sleeve 521 of this embodiment have the same structures and functions as those of the bearing 1 or 1A, the bearing structure 2, the shaft 3 and the sleeve 4 of the above-mentioned embodiment, detailed descriptions thereof will be omitted.

In summary, a hearing is used in conjunction with a shaft and a sleeve. The shaft passes through the hearing, which is disposed in a chamber of the sleeve in the fan, the bearing structure and the bearing thereof according to the invention. The hearing has an axial hole, a plurality of first grooves (and second grooves), a plurality of chamfers and at least one cut side. Compared with the prior art, when the hearing is rotating, the invention utilizes the first grooves (and second grooves), the chamfers and the cut side to sufficiently mix the lubrication fluid oil gas to form a circulating lubrication loop. In addition, the gap between the bearing and the sleeve contains oil gas such that the oil gas hydrodynamic pressure is generated on the top surface and the periphery of the bearing. Thus, the thrust functions in the axial and radial directions can be generated in order to prevent the bearing from rubbing against the top surface and The inner wall of the sleeve, and to reduce up and down vibrations of the bearing and the pneumatic hammer phenomena without the use of a conventional resisting washer. In addition, the invention forms the circulating loop of the lubrication fluid in the closed chamber. Thus, the consumption and volatilization of the lubrication fluid can be reduced, the lifetime of the hearing can be lengthened, and the manufacturing cost can be decreased because the machining precision of the bearing does not have to be very high.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A hearing, which is used in conjunction with a shaft and disposed in a sleeve, the bearing comprising:
an axial hole for passing the shaft therethrough;
a plurality of first grooves formed on an inner wall of the bearing and extending to a top surface of the bearing; and
a plurality of second grooves formed on an outer wall of the bearing,
wherein the first grooves directly extend through a top surface of the bearing to a periphery of the bearing, and the first grooves connect the corresponding second grooves.

2. The hearing according to claim 1, wherein the bearing further comprises a plurality of chamfers formed at connection portions between the first grooves and the top surface of the bearing, and the chamfer has a sloped surface or an arced surface.

3. The bearing according to claim 1, wherein the bearing further comprises at least one cut side formed on an outer periphery of the bearing.

4. The hearing according to claim 1, wherein the sleeve has an opening formed at a bottom thereof, a positioning part on an inner wall thereof for positioning the bearing accommodated in the sleeve, and the opening is sealed by a sealing element.

5. The bearing according to claim 4, wherein the positioning part and the sleeve are integrally formed as a monolithic piece.

6. The bearing according to claim 4, wherein the sealing element and the sleeve are integrally formed as a monolithic piece.

7. The bearing according to claim 1, wherein a top of the sleeve is formed with an opening, which is sealed by a cover, and the shaft passes through a through hole at a middle of the cover.

8. A hearing comprising:
an axial hole;
a plurality of first grooves formed on an inner wall of the bearing and extending to a top surface of the hearing; and
a plurality of second grooves formed on an outer wall of the bearing,
wherein the first grooves directly extend through the top surface of the hearing to a periphery of the bearing, and the first grooves connect the corresponding second grooves.

9. The bearing according to claim 8, wherein the first grooves extend in a direction parallel to an axial direction of the axial hole, or extend helically on the inner surface of the axial hole.

10. The hearing according to claim 8, wherein the outer wall is opposite to the inner wall.

11. The bearing according to claim 8, further comprising a plurality of chamfers formed at connection portions between the first grooves and the top surface of the bearing, and the chamfer has a sloped surface or an arced surface.

12. The bearing according to claim 8, further comprising at least one cut side formed on an outer periphery of the hearing and disposed symmetrically.

13. A fan comprising:
an impeller comprising a hub and a plurality of blades mounted around the hub; a stator structure comprising a magnetic element and a sleeve;
a rotor structure disposed corresponding to the stator structure, wherein the rotor structure has a shaft connected to the hub; and
a bearing structure disposed in the sleeve comprising:
an axial hole for passing the shaft therethrough;
a plurality of first grooves formed on a first wall of the bearing and extending to a top surface of the hearing; and
a plurality of second grooves formed on an outer wall of the bearing.
wherein the first grooves directly extend through the top surface of the bearing to a periphery of the bearing, and the first grooves connect the corresponding second grooves.

14. The hearing according to claim 13, wherein the sleeve has an opening formed at a bottom thereof, a positioning part on an inner wall thereof for positioning the hearing accommodated in the sleeve, and the opening is sealed by a sealing element.

15. The bearing according to claim 13, wherein the sealing element and the sleeve are integrally formed as a monolithic piece.

16. The bearing according to claim 13, wherein the first grooves extend in a direction parallel to an axial direction of the axial hole, or extend helically on the inner surface of the axial hole.

17. The bearing according to claim 13, further comprising a plurality of chamfers formed at connection portions between the first grooves and the top surface of the bearing, and the chamfer has a sloped surface or an arced surface.

18. The hearing according to claim 13, further comprising at least one cut side formed on an outer periphery of the bearing and disposed symmetrically.
